(19) United States
(12) Patent Application Publication
(10) Pub. No.: US 2020/0169088 A1
(43) Pub. Date: May 28, 2020

(54) DRILLING RIG ELECTRICAL SYSTEM WITH BATTERY ASSIST

(71) Applicant: Integrated Drive Systems LLC, Houston, TX (US)

(72) Inventors: Norman S. Myers, Spring, TX (US); Craig Sims, La Vernia, TX (US); Riadh Benguedda, Cypress, TX (US)

(21) Appl. No.: 16/201,720

(22) Filed: Nov. 27, 2018

(51) Int. Cl. H02J 3/32; H02J 3/38; H02J 7/00; H02J 7/34

(52) U.S. Cl. CPC H02J 3/32; H02J 7/34; H02J 7/0068; H02J 3/381

(57) ABSTRACT

Embodiments described herein relate to a drilling rig electrical system. An example system in accordance with embodiments can include one or more engine generators to provide (Alternating Current) AC electrical power to an AC bus, a rectifier to convert AC electrical power from the AC bus to Direct Current (DC) electrical power of a DC bus, and drilling rig equipment coupled to the DC bus. The drilling rig equipment can include a drawworks inverter configured to draw electrical power from the DC bus. The drilling rig system also includes an energy storage device to store electrical energy received from the DC bus. The energy storage device includes a battery bank and a DC to DC converter coupled between the battery bank and the DC bus. The DC to DC converter is configured to switch between a battery charging mode and a battery discharging mode based on a DC bus voltage.

### TECHNICAL FIELD

The present disclosure describes improved drilling rig electrical systems. More specifically, the disclosure describes a drilling rig electrical system with an electrical energy storage device.

### BACKGROUND

Modern drilling rigs are complex systems with a wide variety of electrical components used for drilling oil wells, natural gas extraction wells, and other types of wells. For example, most drilling rigs include some sort of drawworks for raising or lowering a drill string within the borehole, as well as a top drive for rotating the drill string and/or the drill bit. In some systems, drilling fluid, commonly referred to as mud, is injected into the borehole during drilling to cool and lubricate the drill bill and remove cuttings from the borehole. Some drilling rigs may also be mobile and use some form of locomotion to relocate the drilling rig unit across a foundation pad between plural discreet drilling locations. Many of these various systems rely on the use of electrical motors controlled, for example, by variable frequency drives. A host of additional components may be employed to power and control the various systems. The electrical energy used to power the various systems is often provided by one or more electrical generators, such as diesel powered engine generators or a combination of diesel and natural gas engine generators.

### BRIEF DESCRIPTION OF THE DRAWINGS

The disclosed subject matter will best be understood by reference to the following detailed description of example embodiments when read in conjunction with the accompanying drawings, wherein:

FIG. 1 is a block diagram of a drilling rig system in accordance with embodiments.

FIG. 2 is a circuit diagram of an example energy storage device in accordance with embodiments.

FIG. 3 is a circuit diagram of an example drilling rig system in accordance with embodiments.

FIG. 4 is a circuit diagram of another example drilling rig system in accordance with embodiments.

FIG. 5 is a process flow diagram illustrating an example method of operation of a drilling rig electrical system.

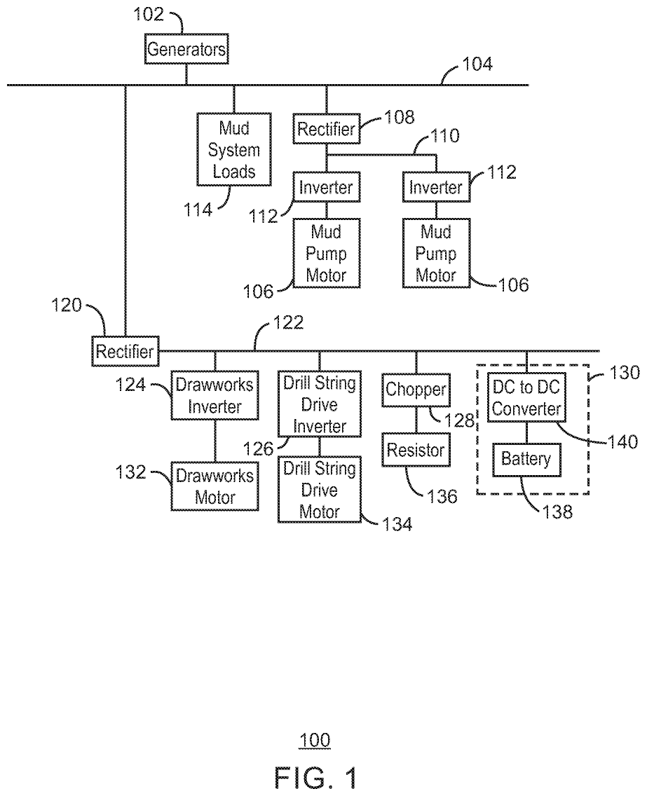

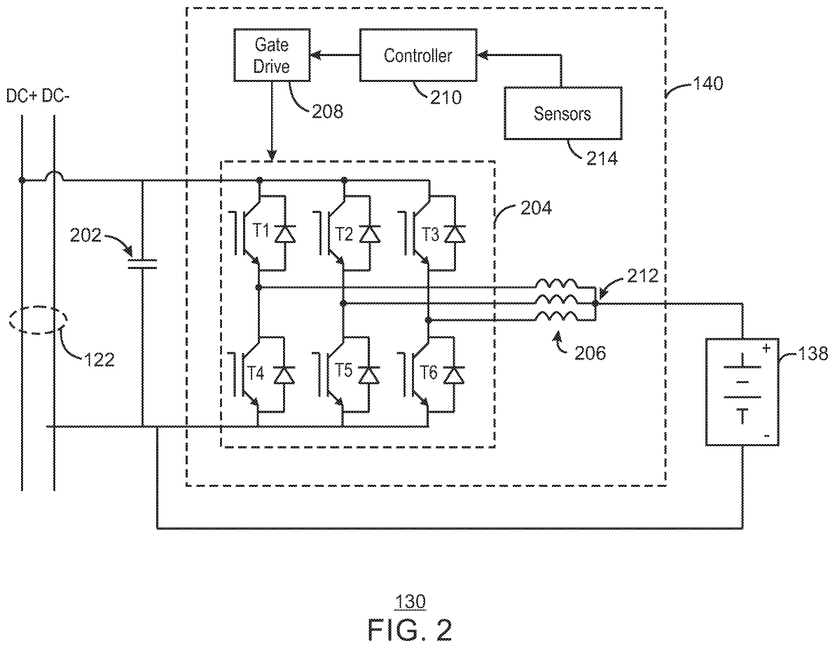

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

The present disclosure describes techniques for providing electrical energy to a drilling rig. More specifically, the disclosure describes techniques for powering a drilling rig that provides a stable energy source that is responsive to changing load conditions. As an example, peak load conditions may be experienced any time the drawworks is engaged to lift or lower the drill string, a process commonly referred to as “tripping.” During such an operation, the electrical loading will usually peak during the initial acceleration of the drill string and level off after drill string obtains maximum speed. The drill string acceleration may last for a duration of anywhere from one to fifteen seconds. To provide the additional energy used during drill string acceleration, the electrical generators may respond by ramping up to satisfy the additional loading. However, the engines typically used in such generators tend to respond too slowly to dynamic load changes due to pollution control regulations. The usual solution to this problem is to run an additional engine generator that can be powered up during peak load conditions. During tripping, the extra engine generator is typically run to handle the peak loading caused by the drawworks. Running an extra generator to only handle the peak load caused by accelerating the drawworks adds additional maintenance cost to the drilling rig and adds to the overall fuel consumption of the drilling rig.

The present disclosure provides techniques for responding to dynamic loading conditions without the use of an additional online engine generator. As described further below in relation to the accompanying figures, the engine generators generate alternating current (AC) electrical power which is delivered to an AC bus. This AC electrical energy is then converted to direct current (DC) electrical energy to distribute to various systems, such the drawworks, over a DC bus. The drawworks is powered by an AC motor, which draws energy form the DC bus through an inverter such as a variable frequency drive.

Also coupled to the DC bus is an energy storage system, which is configured to provide additional energy to the DC bus during high load conditions. The energy storage system includes one or more batteries coupled to the DC though a DC to DC converter. During normal loading conditions, the batteries receive a charge from the DC bus through the DC to DC converter. During high load conditions, such as drill string acceleration, the voltage on the DC bus will tend to drop. When the voltage drops to a sufficient level, the process reverses and the batteries provide additional energy to the DC bus through the DC to DC converter. In this way, the additional power used during high load conditions is provided by the energy stored to the batteries, rather than the extra engine generator. Accordingly, the extra engine generator may remain off, which results in fuel savings and reduced engine wear. In some cases, the drilling rig may not be equipped with an extra engine generator, which provides even further cost reductions and system simplification.

As used herein, the term “approximately” is used to reflect the fact that the actual electrical characteristics will be affected by various factors that may cause deviation from nominal design values. For example, the actual bus voltage values may vary depending on design tolerances of the electrical circuits used, performance characteristics of the power generating equipment, the loading characteristics exhibited by the drilling rig equipment, and resistive losses through conductors, among others. Due to these factors, the actual bus voltage values may be expected to vary by as much as 10 to 15 percent from the nominal bus voltages used herein.

FIG. 1 is a block diagram of a drilling rig system in accordance with embodiments. The drilling rig system 100 shown in FIG. 1 provides electrical power for various equipment used for drilling a well such as an oil well, a natural gas extraction well, and the like. The drilling rig system 100 may be used in a variety of drilling rig types. For example, the drilling rig may be a stationary rig, a mobile rig, an offshore platform, and others.

The drilling rig system 100 may include one or more AC electrical generators 102. The generators 102 may be engine-powered synchronous or induction generators that run on any suitable fuel, including diesel, natural gas, and others. The generators 102 generate AC electrical power, which is delivered to various components of the drilling rig through an AC bus 104. Any suitable number of generators may be included, depending on the power demands of the drilling rig and associated components.

The drilling rig system 100 may also include a mud pump system. The mud pump system includes a number of mud pumps 106, which move drilling fluid through the bore hole. The example mud pump system shown in FIG. 1 includes a rectifier 108 to convert AC power from the AC bus 104 to DC power, which is distributed to the mud pumps 106 over a DC bus 110. Each mud pump 106 is coupled to an inverter 112, which converts DC power received from the DC bus 110 to an AC inverter signal suitable for driving the respective mud pump 106 at a desired speed. The inverter 112 may be any suitable type of DC to AC inverter, including Insulated Gate Bipolar Transistors (IGBTs), and others. It will be appreciated that the mud pump system shown in FIG. 1 is one example of a mud pump system and that various alterations may be made depending on the design of a particular implementation. For example, additional rectifiers 112 and more or fewer mud pumps 106 may be included. The drilling rig system 100 may also include additional mud system loads 114, such as shakers, centrifuges, mud tank pumps, and others.

The drilling rig system 100 may be configured to perform drilling functions and operations. It will be understood that different embodiments of the drilling rig system 100 can include any suitable drilling rig, including drilling rigs of different configurations, arrangements, and appearances, and can be of different manufacture. The drilling rig equipment receives AC electrical power from the generators 102 through the AC bus 104. The AC electrical power from the AC bus 104 is converted to DC power by a rectifier 120, which is distributed to the drilling rig equipment through another DC bus 122. The rectifiers 108 and 120 may be any suitable type of AC to DC rectifier, including a full-wave diode bridge, half-wave diode bridge, and others.

The drilling rig equipment may include, without limitation, a drawworks inverter 124, a drill string drive inverter 126, a braking chopper 128, and an energy storage device 130, all of which are coupled to the DC bus 122. The drawworks inverter 124 delivers a drive signal to a drawworks motor 132, which provides the motive power for raising and lowering the drill string. In some examples, the drawworks inverter 124 is a variable frequency drive that includes a controller and a local or remote operator interface. The operator interface enables the drill rig operator to vary the motor speed and torque of the drawworks motor 132 by, for example, varying the output frequency and voltage of the drawworks inverter 124.

The drill string drive inverter 126 delivers a drive signal to a drill string drive motor 134, which provides the torque for rotating the drill string and/or drill bit to form the borehole. The drill string drive may be any suitable configuration, including top drive, rotary table, Kelly drive, and others. In some examples, the drill string drive inverter 126 is another variable frequency drive that includes a controller and a local or remote operator interface. The drill rig operator can vary the motor speed and torque of the drill string drive motor 134 by varying the output frequency and voltage of the drill string drive inverter 126 through the operator interface.

The braking chopper 128 is a circuit configured to limit the voltage on the DC bus when the drilling rig equipment, such as the drawworks motor 132 or the drill string drive motor 134, feeds regenerative braking energy back to the DC bus 122. The braking chopper 128 may operate by switching current through a resistor 130 if the DC bus voltage exceeds a specified threshold. Other techniques for handling braking energy are also possible, and in some implementations the braking chopper 128 may be eliminated.

The energy storage device 130 is configured to provide additional electrical power to the DC bus 122 during periods of increased loading. During periods of increased loading such as lifting the drill string, the energy drawn by the drawworks inverter 124 may exceed the capability of the generators 102 to provide a stable voltage to the DC bus 104. If this happens and additional electrical energy is not provided, the DC bus voltage may drop to a level at which the drawworks inverter 124 may not be able to provide enough power to the drawworks motor 132. To avoid this, additional generators may be brought online. However, as mentioned above, this results in additional fuel consumption and also relies on the use of an extra standby generator. The energy storage device 130 eliminates the need for such additional energy generation.

The energy storage device 130 includes a battery bank 138 coupled to the DC bus 122 through a DC to DC converter 140. The storage capacity of the battery bank 138 may be sized to provide enough energy to support the DC bus voltage during peak loading conditions, for example, during drill string acceleration which may last for a period of approximately one to fifteen seconds. In some examples, the battery bank 138 may include a plurality of batteries coupled in series and/or in parallel at the output of the DC to DC converter 140. Example battery types that may be used in the energy storage device include lead-acid batteries, lithium-ion batteries, lithium-titanate batteries, and others. The battery bank 138 may also include high-capacity capacitors (sometimes referred to as “supercapacitors” or “ultracapacitors”) or a combination of batteries and high-capacity capacitors. In some embodiments, the total storage capacity of the battery bank 138 may be approximately 25 to 200 kilowatt hours depending on the design considerations of a particular implementation. In some embodiments, the total storage capacity of the battery bank 138 may be as high as approximately 500 kilowatt hours or more.

The DC to DC converter 140 converts the voltage of the DC bus to a reduced voltage level that is suitable for charging the batteries. Additionally, the DC to DC converter 140 allows current to flow in the reverse direction from the battery to the DC bus if the DC bus voltage drops below a programmable threshold voltage level. The DC to DC converter 140 may be any suitable type of DC to DC converter, including a switch mode power supply, a single phase or multi-phase buck converter, synchronous buck converter, and others.

During normal loading conditions, the battery receives charging current from the DC bus under the control of the DC to DC converter 140. If the bus voltage drops below a threshold level, the energy stored to the battery flows back to the DC bus to maintain the DC bus voltage at a high enough level to handle the additional loading. An example energy storage device with a DC to DC converter is described further in relation to FIG. 2.

In some examples, the energy storage device 130 may be included as an integrated component of the drilling rig. For example, the energy storage device 130 may be housed within the same equipment house as the other electrical components of the drilling rig such as the drawworks inverter 124 and others. In some examples, the energy storage device 130 is a separate component that can be used, for example, to upgrade or retrofit an existing drilling rig. For example, the energy storage device 130 may be housed within a separate portable electrical enclosure that houses the battery bank and the DC to DC converter separately from other components of the drilling rig. In this example, the portable electrical enclosure may be supported from below in manner that enables the energy storage device 130 to be moved into place alongside the drilling rig. For example, the portable electrical enclosure may be mounted on a pallet or skid. The portable enclosure can bet set near the drilling rig power control room where the drawworks inverter 124 is located. Additionally, connector cables may extend through a wall of the portable electrical enclosure to enable the energy storage device 130 to be coupled to the DC bus 122 of the drilling rig. The connector cables may include two DC connectors, which may be configured to plug into two DC receptacles of the DC bus that feeds the drawworks inverter 124. In some examples, a data communication fiber may also be included for monitoring the voltage level of the DC bus.

It is to be understood that the block diagram of FIG. 1 is not intended to indicate that the drilling rig system is to include all of the components shown in FIG. 1. Rather, the drilling rig system can include fewer or additional components not illustrated in FIG. 1. Furthermore, the components may be coupled to one another according to any suitable system design, including the system design shown in FIG. 1 or any other suitable system design that uses a DC bus to power drilling rig equipment. For example, in the some embodiments, the drilling rig includes a relocation system (not shown) configured to enable relocation movement of the drilling rig between drilling locations across foundation pad, for example. A suitable relocation system may include, for example, a walking mechanism, a set of wheels, a set of tracks, or combinations thereof.

It will be further understood that the drilling rig equipment can include additional equipment not shown in FIG. 1, such as hydraulic equipment, hoists, pipe tongs, joint elevators, wrenching equipment, additional electric motors, pumps, rotary tables, lifting equipment, lighting systems, catwalk, iron roughneck, power tongs, and others. The drilling rig system also includes a driller's control system and human machine interface (HMI) for an operator of the drilling rig. A driller's control system can include rig equipment controls and data communications equipment and controls configured to enable control and operation of drilling rig system.

FIG. 2 is a circuit diagram of an example energy storage device in accordance with embodiments. As described above, the energy storage device 130 is configured to provide additional electrical power to the DC bus during periods of increased loading. The energy storage device shown in FIG. 2 includes a three-phase DC to DC converter 140, a capacitor202, and a battery bank 138.

The DC to DC converter 140 includes an IGBT module 204, inductors 206, a gate driver 208, and a controller 210. The IGBT module 204 includes six Insulated Gate Bipolar Transistors (IGBTs) each with an antiparallel diode coupled across the collector and drain terminals. In the embodiment shown in FIG. 2, the IGBTs of the IGBT module are arranged to form a three phase synchronous buck-boost converter. The IGBTs and their associated diodes are labeled T1 to T6. IGBTs T1 and T4 form a first leg associated with a first phase, IGBTs T2 and T5 form a second leg associated with a second phase, and IGBTs T3 and T6 form a third leg associated with a third phase. The output of each leg is coupled to the positive terminal, i.e., cathode, of the battery bank 138 through one of the inductors 206. The negative terminal, i.e., anode, of the battery bank 138 is coupled to the negative side of the DC bus 122.

The input of the DC to DC converter 140 is coupled to the positive and negative sides of the DC bus 122. The capacitor 202 is coupled across the input terminals to reduce voltage ripple. In some embodiments, several capacitors 202 may be coupled across the input terminals in series and/or parallel depending on the capacitance level suitable for a particular implementation. The controller 210 controls the activation of the IGBTs by controlling the operation of the gate driver 208. During charging, the legs of the IGBT module 204 are switched sequentially in three non-overlapping phases to generate a specified voltage level at the output of the inductors 206. The result is that the voltage at the output of the DC to DC converter 140 will be reduced compared to the voltage of the DC bus 122. The specific voltage level may be controlled by controlling the switching frequency and the duty cycle of each leg of the DC to DC converter 140.

The battery bank 138 can include any suitable number of batteries. The coupling between the batteries may be configured depending on the desired voltage and current capacity. For example, in one embodiment, the battery bank 138 may include parallel strings of battery modules, such as lithium-titanate battery modules. Each battery module may have multiple individual battery cells arranged to provide a specified voltage and current capacity per module. During battery charging, the voltage at the output of the DC to DC converter 140 allows the battery bank 138 to charge at a suitable voltage level, which is lower than the DC bus voltage. The voltage level at the output of the DC to DC converter 140 may be specified based on the battery type, the number of batteries, and the coupling configuration of the batteries.

The DC to DC converter 140 operates in a battery charging mode and a battery discharging mode. In some embodiments, the controller 210 may be configured to sense the voltage at the DC bus 122 and switch the DC to DC converter 140 between the charge mode and the discharge mode if the DC bus voltage drops below a threshold level. As used herein, the output of the DC to DC converter 140 is defined as the output of the inductors 206 at node 212. Additionally, it will be appreciated that the DC to DC converter 140 will feed electrical energy from the battery bank 138 to the DC bus 122 during the battery discharging mode. However, for the sake of clarity, the node 212 will be referred to as the “output” of the DC to DC converter 140 whether operating in the battery discharging mode or battery charging mode.

During battery charging mode, the DC to DC converter 140 operates as a three-phase buck converter. While acting as a buck converter, the T1 IGBT is cycled between an on state and an off state. When the T1 IGBT is on, current flows from the positive side of the DC bus through the associated output inductor 206. While the T1 IGBT is off, freewheeling current generated by the inductor 206 passes through the T4 diode. Each leg of the IGBT module 204 is operated in the same manner with a phase difference between the switching cycles so that each leg contributes to the resulting voltage at the output of the DC to DC converter 140. The switching frequency and duty cycle is controlled to produce a specified voltage at the output of the DC to DC converter 140 which will be lower than the DC bus voltage. The lower voltage at the output of the DC to DC converter 140 provides a voltage level suitable for charging the battery bank 138.

During battery discharging mode, the DC to DC converter 140 operates as a three-phase boost converter, and boosts the voltage seen at the DC bus 122 from the battery bank 138 to level that enables current from the battery bank 138 to flow back the DC bus 122. While acting as a boost converter, the T4 IGBT is cycled between an on state and an off state. When the T4 IGBT is on, current flows from the positive side of the battery bank 138 to ground through the associated inductor 206. While the T4 IGBT is off, current from the battery bank 138 flows to the positive side of the DC bus 122 through the inductor 206 and the T1 diode. Each leg of the IGBT module 204 is operated in the same manner with a phase difference between the switching cycles so that each leg contributes to the resulting current flow back to the DC bus 122. The switching frequency and duty cycle is controlled to produce a specified voltage at the DC bus-side of the inductors 206 which is higher than the voltage at the battery bank-side of the inductors 206, i.e., node 212. The boosted voltage enables the battery bank 138 to discharge to the DC bus 122.

In some embodiments, the DC to DC converter 140 also includes one or more sensors 214 to detect the voltage and/or current at various nodes of the DC to DC converter 140. For example, the sensors may include a voltage sensor to detect the bus voltage at the input of the DC to DC converter 140. The controller 210 can use the detected bus voltage to switch between the battery charging mode and the battery discharging mode. The sensors may also include another sensor to detect the voltage and/or current at the output of the IGBT module or the DC to DC converter 140. The detection of the voltage and/or current may be used by the controller 210 to control the output voltage of the DC to DC converter 140 through a feedback loop.

It is to be understood that the circuit diagram of FIG. 2 is not intended to indicate that the energy storage device 130 is to include all of the components shown in FIG. 2. Rather, the energy storage device 130 can include fewer or additional components not illustrated in FIG. 2. Additionally, the energy storage device 130 of FIG. 2 is one example of an energy storage device 130 in accordance with embodiments. For example, in some embodiments, the energy storage device 130 may include two or more IGBT modules 204 coupled to the battery bank 138 in parallel. Additionally, the DC to DC converter 140 may include more or fewer phases compared to the DC to DC converter 140 shown in FIG. 2.

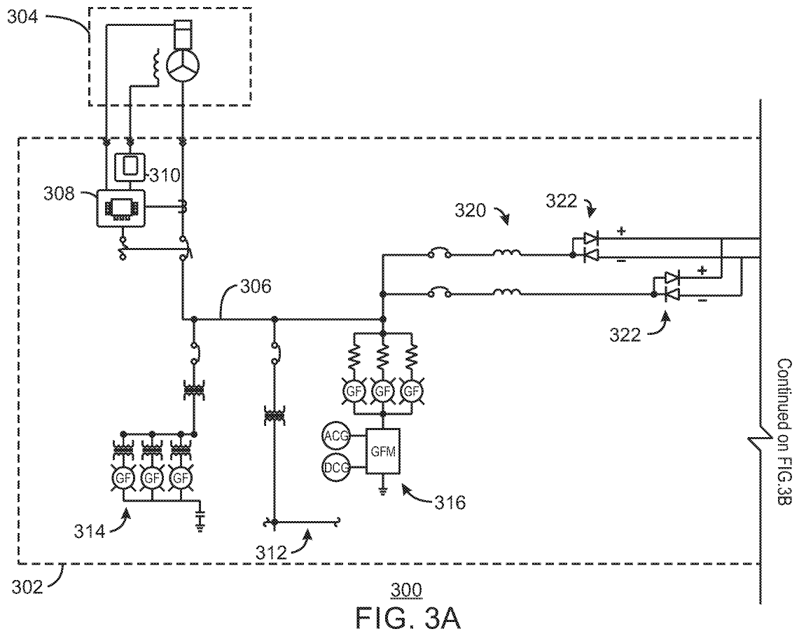

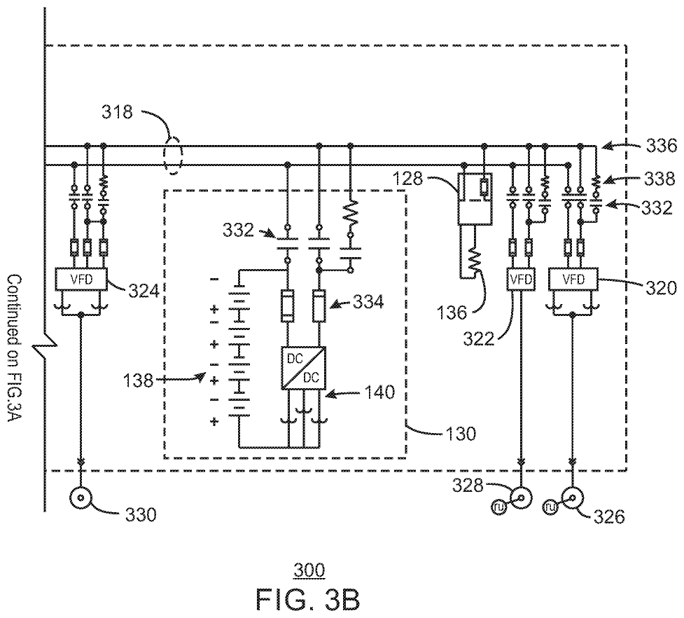

FIG. 3 is a circuit diagram of an example drilling rig system in accordance with embodiments. In the embodiment shown in FIG. 3, the drilling rig system 300 includes a power control house 302, which houses the power generation equipment for the drilling rig. The embodiment shown in FIG. 3 may be useful in implementations where the drilling rig in not mobile. The power control house 302 receives AC electrical power from a group of generators 304 coupled to the AC bus 306 in parallel. In some embodiments, the generators 304 may be diesel engine-generators or dual fuel diesel and natural gas generators. Each generator 304 may be capable of providing three-phase primary power at 600 Volts AC (VAC) on the AC bus 306. Any suitable number of generators may be used depending on the power requirements for the drilling rig equipment. It will be understood that, the drilling rig system 300 may be configured to operate at other voltage levels and that the specific values provided herein are provided merely as examples.

The generators 304 may be controlled by a paralleling gen-set controller 308 and Analog Voltage Regulator 310. The paralleling gen-set controller 308 controls the starting and stopping of the engines, closing of circuit breakers, and coordinates the load sharing of the online engine generators. The Analog Voltage Regulator 310 is configured to maintain a constant output voltage via a feedback loop.

Various components may be coupled to the AC bus such as a lighting system 312, and ground fault monitors 314 and 316. The AC bus 306 is also coupled to a DC bus 318 through a pair of inductors 320 and a pair of diode bridges 322. The inductors 320 act as filters, which can reduce voltage ripple on the DC bus 318. The diode bridges 322 rectify the AC electrical power received from the AC bus 306 and generate DC electrical power which is distributed over the DC bus 318. The resulting DC bus voltage will be a multiple of the AC voltage on the AC bus. For example, if the nominal AC bus voltage is 600 VAC, the nominal DC bus voltage will be approximately 810 volts.

Coupled to the DC bus 318 are the drawworks VFD 320, the top drive VFD 322, and a mud pump VFD 324, which are controlled to provide a regulated voltage and frequency for driving the drawworks motor 326, top drive motor 328, and the mud pumps 330, respectively. In some embodiments, the drilling rig system 300 also includes a braking chopper coupled to the DC bus 318. Each connection to the positive and negative sides of the DC bus may be made through a DC contactor 332 and a fuse 334. Additionally, each component may be coupled to the DC bus through a pre-charge circuit 336, which includes a DC contactor 332 in series with a resistor 338. The pre-charge circuit 336 may be engaged when the system first powers up to enable the circuitry within each component to charge gradually at the initial power up.

The positive and negative sides of the DC bus 318 are coupled to the input of the DC to DC converter 140, which may be the DC to DC converter 140 shown in FIG. 2. In the embodiment shown in FIG. 3, the battery bank 138 includes a set of four batteries modules coupled in series between the DC to DC converter 140 and the negative side of the DC bus 318. However, the battery bank 138 may include any suitable number of battery modules with any suitable coupling configuration depending on the design of a particular implementation. In some embodiments, the battery bank 138 may be designed to provide 600 Amps of current at a voltage of 520 to 690 volts for a period of approximately five seconds. This may be accomplished using two parallel strings of twenty five battery modules, where each battery module is rated for 20.8 to 27.6 volts and has a discharge capacity of 300 amps. An example of a battery module for this application may include a plurality of lithium-titanate cells.

During non-peak loading, the DC to DC converter 140 is operating in charging mode. Following the example described above, the DC to DC converter 140 may convert the DC bus voltage of 810 volts down to approximately 700 volts at the cathode of the battery bank 138, allowing the battery bank 138 to charge without applying excessive voltage to the battery bank 138. The DC to DC converter 140 is configured to detect the voltage at the DC bus 318 and switch to the discharge mode if the DC bus voltage drops below a threshold voltage level. The threshold voltage level may be programmed into the logic of the DC to DC converter 140 and may be referred to herein as the voltage threshold set point. For a nominal DC bus voltage of 810 volts, the threshold voltage set point may be approximately 780 volts, for example. During discharge mode, current passes from the battery bank 138 to the DC bus through the DC to DC converter 140. The DC to DC converter 140 boosts the voltage from the battery bank 138 to enable the current to flow to the DC bus. For example, the voltage at the DC bus-side of the inductors may be boosted to approximately 500 to 700 Volts.

When the loading returns to normal levels, the DC bus voltage will start to increase due to the power provided by the generators 304. When the DC to DC converter 140 detects that the voltage at the DC bus 318 is above the voltage threshold set point, the DC to DC converter 140 can switch back to the battery charging mode.

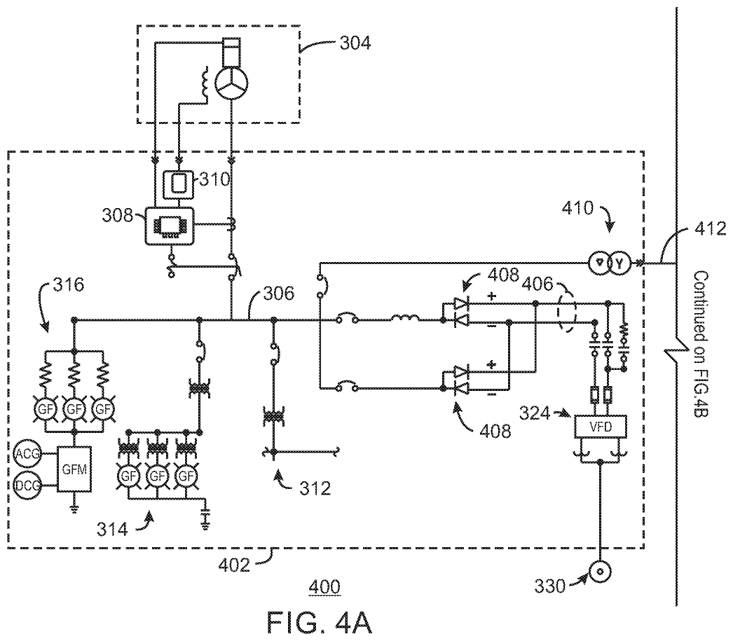

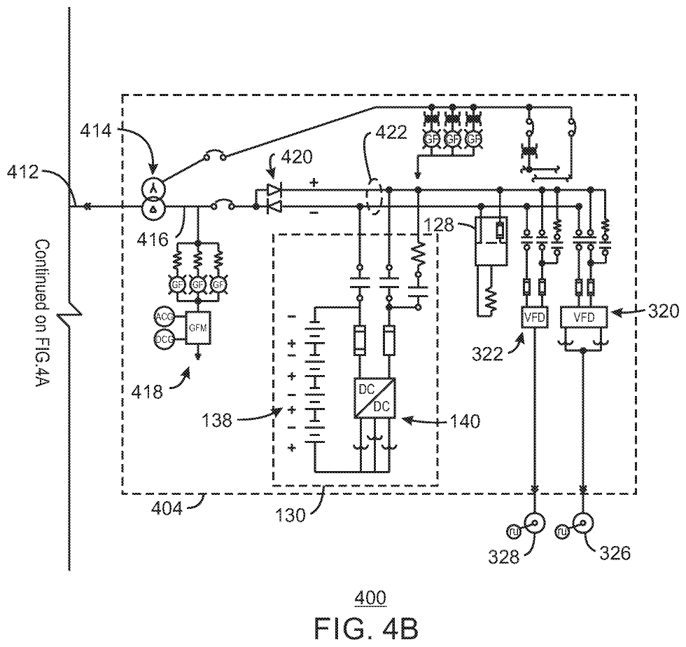

FIG. 4 is a circuit diagram of another example drilling rig system in accordance with embodiments. In the embodiment shown in FIG. 4, the drilling rig system 400 includes a power control house 402 and a mobile drilling rig 404. The power control house 402 receives AC electrical power from a group of generators 304 coupled to the AC bus 306 in parallel with one another. The power control house 402 includes the primary power generation equipment for the drilling rig 404 as well as additional equipment that remains in a stationary relationship with respect to the power house 402. For example, the power control house 402 may include the lighting system 312 and ground fault monitors 314 and 316. In some embodiments, the power control house 402 may also include the mud pump VFD 324. The mud pump VFD 324 may be coupled to a DC bus 406 generated by a pair of diode bridges 408 coupled to the power house AC bus 306. The components that are included in and travel with the mobile drilling rig 404 include the drawworks VFD 322, drawworks motors 326, the top drive VFD 322, top drive motor 328, the braking chopper 128, the energy storage device 130, and others.

Various techniques exist for delivering power from the generators 304 to the mobile drilling rig 404. For example, the equipment in the mobile drilling rig 404 may be coupled to the AC bus 306 of the power house 402 using a plurality of 600 VAC intermediate cables extending from the power house 402 to the drilling rig 404. In the embodiment shown on FIG. 4, the drilling rig system 400 includes an intermediate electrical system configured to carry power from the power house electrical system to the drilling rig electrical system for powering the rig equipment. The intermediate electrical system can be used to eliminate the large number of power cables and draglinks or festoons necessary to hand multiple long cables and minimize the number of power connector assemblies and components.

The intermediate electrical system may include a step-up transformer 410 coupled to the AC bus 306 of the power house electrical system, an intermediate conductor 412 configured to carry three-phase AC power to the drilling rig electrical system, and a step-down transformer 414 coupled to the AC bus of the drilling rig electrical system. The step-up transformer transforms AC electrical power received from the power house AC bus 306 to intermediate power at high voltage, where the AC bus voltage is lower than the high voltage of the intermediate power. For example, the step-up transformer 410 may transform the AC bus voltage at 600 VAC to intermediate power at 4160 VAC. The step-down 414 transformer transforms intermediate power received through the intermediate conductor 412 from the high voltage down to the lower AC bus voltage of the drilling rig AC bus 416. For example, the step-down transformer 414 may transform the power received through the intermediate conductor 412 at 4160 VAC down to the drilling rig AC bus voltage at 600 VAC. It will be understood that the voltage levels of the power house AC bus 306, intermediate conductor 412, and the drilling rig AC bus 416 can differ from the particular values set forth in the embodiments described herein.

Although not shown, the drilling rig system 400 can also include releasable power connector assemblies configured for releasable mating engagement of the intermediate conductor with the power house electrical system and the drilling rig electrical system, and a conductor carrier reel that can be rotated to enable the intermediate conductor to be extended or retracted during movement of the drilling rig relative to the power house.

Various types of drilling rig equipment may be coupled to the AC bus 416 of the drilling rig electrical system, including a ground fault monitor 418. The drilling rig electrical system also includes a diode bridge 420 configured to convert the AC power received from the step-up transformer 414 to the DC power distributed over the drilling rig DC bus 422.

The drilling rig electrical system includes the energy storage device coupled to the DC bus. The energy storage device operates as described above, and includes the battery bank 138 and the DC to DC converter 140. As described above, the DC to DC converter 140 can operate in the battery charging mode during non-peak loading conditions, and can switch to battery discharging mode during increased loading conditions based on detecting the DC bus voltage. When the loading returns to normal levels, the DC bus voltage will start to increase due to the power provided by the generators 304. When the DC to DC converter 140 detects that the voltage at the DC bus 422 is above the set point of the DC to DC converter 140, the DC to DC converter 140 can switch back to the battery charging mode.

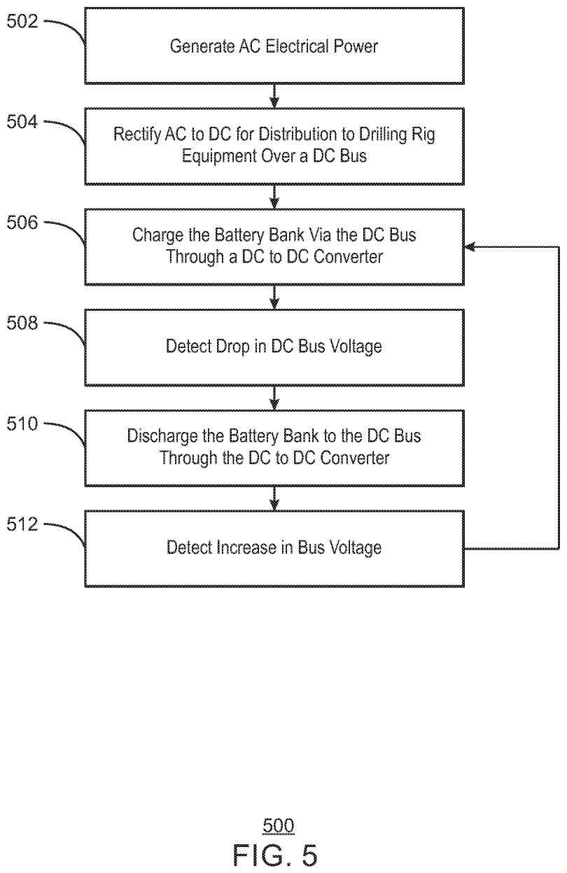

FIG. 5 is a process flow diagram of a method operating a drilling rig electrical system. The method may be performed by any of the example drilling rig systems described herein. The method may begin at block 502.

At block 502, AC electrical power is generated. For example, the AC electrical power may be generated by one or more engine generators, such as the engine generators 102 described in relation to FIG. 1, or the engine generators 304 described in relation to FIGS. 3A and 4A. The AC electrical power may be distributed to various components of the drilling rig system over an AC bus.

At block 504, the AC electrical power is converted to DC electrical power for distribution to drilling rig equipment over a DC bus. The AC electrical power may be converted to DC electrical power through one or more rectifiers, such as the rectifier 120 described in relation to FIG. 1, the diode bridges 322 described in relation to FIG. 3A, or the diode bridges 408 described in relation to FIG. 4A. The drilling rig equipment can include any suitable type and number of motors, motor drives, and other drilling equipment. Examples of drilling rig equipment include a drawworks inverter and an energy storage device that stores electrical energy to be used to support the DC bus voltage during periods of increased load. The energy storage device may include a battery bank coupled to the DC bus through a DC to DC converter.

At block 506, the battery bank is charged using electrical energy received from the DC bus through the DC to DC converter. Charging the battery bank may include controlling the DC to DC converter to convert the voltage at the DC bus to a lower voltage at the battery bank.

At block 508, a drop in the DC bus voltage is detected. The drop in the DC bus voltage may be caused by one of the rig equipment, such as the drawworks inverter, drawing a high level of power from the DC bus. In some examples, the voltage drop may be detected by the DC to DC controller if the voltage falls below a threshold voltage set point programmed into the DC to DC controller.

At block 510, the battery bank is discharged back to the DC bus. During the discharging mode, current flows from the battery bank to the DC bus through the DC to DC converter. In some embodiments, discharging the battery bank to the DC bus includes switching the DC to DC converter to a battery discharging mode. During battery discharging mode, the DC to DC converter converts the voltage at the battery bank to a higher voltage at the DC bus, which enables the reverse current flow.

At block 512, an increase in the bus voltage is detected. The voltage increase may be detected by the DC to DC controller if the voltage has risen above a voltage threshold, which may be the threshold voltage set point programmed into the DC to DC controller or a different voltage threshold. In response to detecting the return of suitable DC bus voltage levels above the voltage threshold, the battery bank stops discharging and the process flow returns to block 504 at which time the battery is recharged. For example, the DC to DC converter may switch from the battery discharging mode to a battery charging mode.

It is to be understood that the process diagram of FIG. 5 is not intended to indicate that all of the elements of the method 500 are to be included in every case. Further, any number of additional elements not shown in FIG. 5 may be included in the method 500, depending on the details of the specific implementation.

While the present techniques may be susceptible to various modifications and alternative forms, the examples discussed above have been shown only by way of example. It is to be understood that the techniques are not intended to be limited to the particular examples disclosed herein. Indeed, the present techniques include all alternatives, modifications, and equivalents falling within the true spirit and scope of the appended claims.

What is claimed is:

1. A drilling rig electrical system comprising:
one or more engine generators to provide (Alternating Current) AC electrical power to an AC bus;
a rectifier to convert AC electrical power from the AC bus to Direct Current (DC) electrical power of a DC bus;
drilling rig equipment coupled to the DC bus, wherein the drilling rig equipment comprises a drawworks inverter configured to draw electrical power from the DC bus;
an energy storage device to store electrical energy received from the DC bus, wherein the energy storage device comprises a battery bank and a DC to DC converter coupled between the battery bank and the DC bus, wherein the DC to DC converter is configured to switch between a battery charging mode and a battery discharging mode based on a DC bus voltage.

2. The drilling rig electrical system of claim 1, wherein the DC to DC converter detects the DC bus voltage and switches from the battery charging mode to the battery discharging mode if the DC bus voltage falls below a voltage threshold set point.

3. The drilling rig electrical system of claim 2, wherein the DC to DC converter switches from the battery discharging mode to the battery charging mode if the DC bus voltage rises above the voltage threshold set point.

4. The drilling rig electrical system of claim 1, wherein the DC to DC converter is configured to convert the DC bus voltage to a second DC voltage at the battery during the battery charging mode, wherein the second DC voltage is lower than the DC bus voltage.

5. The drilling rig electrical system of claim 1, wherein the DC to DC converter is configured to convert a battery voltage at the battery to a third DC voltage at the DC bus during the discharging mode, wherein the third DC voltage at the DC bus is higher than the battery voltage.

6. The drilling rig electrical system of claim 1, wherein the DC to DC converter comprises a three-phase synchronous buck-boost converter.

7. The drilling rig electrical system of claim 1, wherein the battery bank comprises at least one of:
lithium-titanate battery cells;
lithium ion battery cells;
lead-acid battery cells; and
supercapacitors.

8. The drilling rig electrical system of claim 1, wherein the battery bank is configured to provide, during the battery discharging mode, 400 to 700 amperes of current at a battery voltage of 500 to 700 volts for a duration of 5 to 15 seconds.

9. The drilling rig electrical system of claim 1, comprising a second energy storage device to store electrical energy received from the DC bus in parallel with the energy storage device, wherein the second energy storage device comprises a second battery bank and a second DC to DC converter coupled between the second battery bank and the DC bus, wherein the second DC to DC converter is configured to switch between a battery charging mode and a battery discharging mode based on the DC bus voltage.

10. An energy storage device for a drilling rig comprising:
a battery bank;
a DC to DC converter coupled to the battery bank; and
connector cables coupled to the DC to DC converter and configured to enable the battery bank to be electrically coupled to a DC bus of a drilling rig through the DC to DC converter;
wherein the DC to DC converter is configured to:
operate in a battery charging mode to store electrical energy received from the DC bus if a voltage of the DC bus is above a first voltage level; and
operate in a battery discharging mode to supply electrical energy to the DC bus if the voltage of the DC bus is below a second voltage level.

11. The energy storage device of claim 10, wherein the second voltage level is a voltage threshold set point and the DC to DC converter detects the DC bus voltage and switches from the battery charging mode to the battery discharging mode if the DC bus voltage falls below the voltage threshold set point.

12. The energy storage device of claim 10, wherein the first voltage level is a voltage threshold set point and the DC to DC converter detects the DC bus voltage and switches from the battery discharging mode to the battery charging mode if the DC bus voltage rises above the voltage threshold set point.

13. The energy storage device of claim 10, wherein the first voltage level is equal to the second voltage level.

14. The energy storage device of claim 10, wherein the DC to DC converter is configured to convert the DC bus voltage to a second DC voltage at the battery during the charging mode, wherein the second DC voltage is lower than the DC bus voltage.

15. The energy storage device of claim 10, wherein the DC to DC converter is configured to convert a battery voltage at the battery to a third DC voltage at the DC bus during the discharging mode, wherein the third DC voltage at the DC bus is higher than the battery voltage.

16. The energy storage device of claim 10, wherein the DC to DC converter comprises a three-phase synchronous buck-boost converter.

17. The energy storage device of claim 10, wherein the battery bank comprises at least one of:
lithium-titanate battery cells;
lithium ion battery cells;
lead-acid battery cells; and
supercapacitors.

18. The energy storage device of claim 10, wherein the battery bank is configured to provide, during the battery discharging mode, 400 to 700 amperes of current at a battery voltage of 500 to 700 volts for a duration of 5 to 15 seconds.

19. The energy storage device of claim 10, comprising a second energy storage device to store electrical energy received from the DC bus in parallel with the energy storage device, wherein the second energy storage device comprises a second battery bank and a second DC to DC converter coupled between the second battery bank and the DC bus, wherein the second DC to DC converter is configured to switch between the battery charging mode and the battery discharging mode based on the DC bus voltage.

20. The energy storage device of claim 10, comprising an equipment house to house the battery bank and the DC to DC converter separately from the drilling rig, wherein the connector cables extend through a wall of the equipment house to couple to the DC bus of the drilling rig.

21. A method of operating a drilling rig system:
generating DC electrical power for distribution to a drilling rig equipment over a DC bus with a bus voltage, wherein the drilling rig equipment comprises a drawworks and an energy storage device, wherein the energy storage device comprises a battery bank coupled to the DC bus through a DC to DC converter;
charging the battery bank by controlling the DC to DC converter to convert the bus voltage to a second voltage at the battery bank, wherein the second voltage is lower than the bus voltage; and
if the bus voltage drops below a voltage threshold, discharging the battery bank to the DC bus.

22. The method of claim 21, wherein discharging the battery bank to the DC bus comprises operating the DC to DC converter to convert a battery voltage at the battery bank to a third voltage at the DC bus, wherein the third voltage is higher than the battery voltage.

23. The method of claim 22, comprising:
detecting that the bus voltage has dropped below the voltage threshold and, in response, switching the operation of the DC to DC converter from a battery charging mode to a battery discharging mode.

24. The method of claim 23, comprising detecting that the bus voltage has risen above the voltage threshold and, in response, switching the operation of the DC to DC converter from a battery discharging mode to a battery charging mode.
